(19) United States
(12) Patent Application Publication
(10) Pub. No.: US 2026/0302830 A1
(43) Pub. Date: Oct. 1, 2026

(54) HAZARDOUS MECHANICAL ENERGY CONTROL SYSTEM

(71) Applicant: AUTOLOTO, INC., Traverse City, MI (US)

(72) Inventors: Daniel Lawrance Furbush, Post Falls, ID (US); Kenneth David Nickolson, Derry, NH (US)

(21) Appl. No.: 19/704,565

(22) Filed: Jun. 11, 2026

Related U.S. Application Data
(63) Continuation-in-part of application No. 19/068,677, filed on Mar. 3, 2025.
Application No. 19/068,677 is a continuation-in-part of application No. 18/520,844, filed on Nov. 28, 2023, now Pat. No. 12,272,946.
Application No. 18/520,844 is a continuation of application No. 17/684,625, filed on Mar. 2, 2022, now Pat. No. 11,876,372.
Application No. 17/684,625 is a continuation-in-part of application No. 16/868,621, filed on May 7, 2020, now Pat. No. 11,455,851.
(60) Provisional application No. 62/895,169, filed on Sep. 3, 2019.
(60) Provisional application No. 63/821,720, filed on Jun. 11, 2025.

(51) Int. Cl. H02J 13/36; H02J 13/10; H02J 13/13

(52) U.S. Cl. CPC H02J 13/36; H02J 13/10; H02J 13/1337

(57) ABSTRACT

A hazardous energy control system is presented. The system includes a back-end system and a personal electronic device communicatively connected to the back-end system. The personal electronic device provides a user interface for a user to select a set of equipment from the pieces of equipment at the worksite for mechanical energy isolation from hazardous energy sources via lockout/tagout (LOTO). The back-end system is configured to dynamically determine a LOTO procedure for mechanical energy isolation of the set of equipment from the hazardous energy sources based on the energy network data set indicating pieces of equipment, energy isolation devices (EIDs), energy discharge devices (EDDs), and mechanical connections between the pieces of equipment, EIDs, and EDDs on a worksite.

### CROSS REFERENCE TO RELATED APPLICATION

This application claims the benefit of U.S. Provisional Application No. 63/821,720 filed on Jun. 11, 2025, the contents of which is hereby incorporated by reference in its entirety.

This application is a continuation-in-part of U.S. patent application Ser. No. 19/068,677, filed on Mar. 3, 2025, titled “HAZARDOUS ENERGY CONTROL SYSTEM” and published as U.S. Pub. No. 2025/0202277, which is a continuation-in-part of U.S. patent application Ser. No. 18/520,844 filed on Nov. 28, 2023, titled “HAZARDOUS ENERGY CONTROL SYSTEM” and issued as U.S. Pat. No. 12,272,946, which is a continuation of U.S. patent application Ser. No. 17/684,625 filed on Mar. 2, 2022, titled “HAZARDOUS ENERGY CONTROL SYSTEM” and issued as U.S. Pat. No. 11,876,372, which is a continuation-in-part of U.S. patent application Ser. No. 16/868,621 filed on May 7, 2020, titled “HAZARDOUS ENERGY CONTROL SYSTEM” and issued as U.S. Pat. No. 11,455,851 on Sep. 27, 2022, which claims the benefit of U.S. Provisional Application No. 62/895,169 filed on Sep. 3, 2019, the contents of each of which is hereby incorporated by reference in their entirety.

### FIELD OF THE DISCLOSURE

The present disclosure generally relates to systems for managing access to hazardous energy sources and more particularly to lock-out-tag-out systems.

### OVERVIEW

Commercial and industrial settings often have equipment requiring maintenance that may expose workers to many forms of hazardous energy, such as from electrical, mechanical, pneumatic, hydraulic, and others. In order to make equipment safe to work on, the equipment must be disconnected from all energy sources to place the equipment in isolation.

Presently, there exist safety procedures used in industry and research settings to ensure that dangerous energy sources have been properly shut down and are incapable of being started up again prior to the completion of construction, maintenance, or servicing work. The procedures generally require that all hazardous energy sources are identified, isolated, and rendered inoperative to prevent the release of potentially hazardous energy prior to the start of any construction, repair, or maintenance procedures by locking and tagging all energy sources.

Most commonly, safety procedures utilize lockout/tagout (LOTO) processes, which require workers to place locks on energy isolation devices (EIDs) that are switched off in order to isolate a piece of equipment to be serviced. The locks ensure that the energy isolation devices are not accidentally switched on until a worker completes servicing of the equipment and removes their lock from the EID.

Previous systems utilize static pre-defined lock-out-tag-out procedures that are created for each piece of equipment. Such static pre-defined LOTO procedures list all the steps required for a worker to switch off and lock energy isolation devices required to isolate the piece of equipment.

The process to manually create static LOTO procedures is time consuming, and subject to human error. Typically, to create a new LOTO procedure for a single piece of equipment, a trained professional visually traces connections to and from the equipment in project design files (e.g., single line drawings, one-line drawings, electrical architectural drawings, and/or other electrical design schematics, drawings, and/or specifications), which can be very large and challenging to follow, in order to determine which EIDs 46 must be switched off in order to isolate the equipment. This review and determination must be performed for each piece of equipment in order to create the required LOTO procedure. As projects often include large numbers of individual pieces of equipment, creating LOTO procedures can take a significant amount of time. Furthermore, when a system is modified or retrofitted, existing lockout tagout procedures must be reviewed to ensure that the procedures were not affected by the modification/retrofit. Manually updating electrical project design files to reflect current status of energy sources and updating LOTO procedures are also time consuming and subject to human error.

Static pre-defined LOTO procedures are also overly time consuming to perform in the field. For example, when a worker must isolate multiple pieces of equipment, an EID 46 may be listed in two or more LOTO processes. In order to complete each such LOTO process, a unique lock must be placed on the shared EID 46 for each of the LOTO processes to be performed. As a result, multiple unnecessary locks may be placed on the same EID 46. Each unnecessary lock that is placed requires the worker to perform various logging, authorization checks, voltage testing and equipment checks as part of the LOTO process.

Determination of LOTO processes is further complicated in mechanically energized systems, which may require that mechanical energy be safely discharged after equipment is isolated from an energy source. For example, some mechanically energized systems may be driven by or transport various fluids including but not limited to, for example, steam, water, compressed air, hydraulic fluid, flammable liquids or gases, hazardous liquids or gases. As another example, some mechanically energized systems may have mechanical connections (e.g., chains, cables, shafts, belts, cords, links, couplings and/or any other mechanical connection) that may require un-tensioning and/or uncoupling prior to servicing.

Thus, it is a primary object of the disclosure to provide a system for management of LOTO processes that improves upon the state of the art.

Another object of the disclosure is to provide a system for management of LOTO processes for mechanically energized systems;

Yet another object of the disclosure is to provide a system for management of LOTO processes that is safe to use and reduces injuries.

Another object of the disclosure is to provide a system for management of LOTO processes that is more accurate and less time consuming.

Yet another object of the disclosure is to provide a system for management of LOTO processes that improves functionality.

Another object of the disclosure is to provide a system for management of LOTO processes that saves time.

Yet another object of the disclosure is to provide a system for management of LOTO processes that is less error prone.

Another object of the disclosure is to provide a system for management of LOTO processes that is easy to use.

Yet another object of the disclosure is to provide a system for management of LOTO processes that determines LOTO procedures for isolation of a selected set of equipment dynamically on demand based on an energy network data set.

Another object of the disclosure is to provide a system for management of LOTO processes that optimizes determined LOTO procedures to minimize the number of locks required to be placed.

Another object of the disclosure is to provide a system for management of LOTO processes that optimizes determined LOTO procedures to minimize interruption of operation of equipment in an energy network. Yet another object of the disclosure is to provide a system for management of LOTO processes that reduces time required to generate and maintain energy network data sets for a project.

These and other objects, features, or advantages of the present disclosure will become apparent from the specification, claims and drawings.

### SUMMARY

In one or more arrangements, a system for managing access to hazardous energy sources is presented. The system includes a back-end system and a personal electronic device communicatively connected to the back-end system. The back-end system is configured to store an energy network data set indicating pieces of equipment, energy isolation devices (EIDs), energy discharge devices (EDDs), and energy pathways between the pieces of equipment and EIDs on a worksite. The personal electronic device provides a user interface for a user to select a set of equipment from the pieces of equipment at the worksite for mechanical isolation and discharge. In response to the user selecting the set of equipment, the personal electronic device communicates the selected set of equipment to the back-end system. In one or more arrangements, in response to receiving the selected set of equipment, the back-end system is configured to dynamically determine a LOTO procedure for isolation and discharge of the set of equipment based on the energy network data set. In one or more arrangements, in response to receiving the selected set of equipment, the back-end system is additionally or alternatively configured to dynamically determine if a LOTO for the selected equipment already exists and, if so, provides an option for a user to join the existing LOTO. The back-end system then causes the personal electronic device to guide the user through LOTO of the set of equipment for the determined LOTO procedure or joined LOTO.

### BRIEF DESCRIPTION OF THE DRAWINGS

FIG. 1 a schematic view of a hazardous energy control system, in accordance with one or more arrangements; the view showing the system having a back-end system communicatively connected with a personal electronic device.

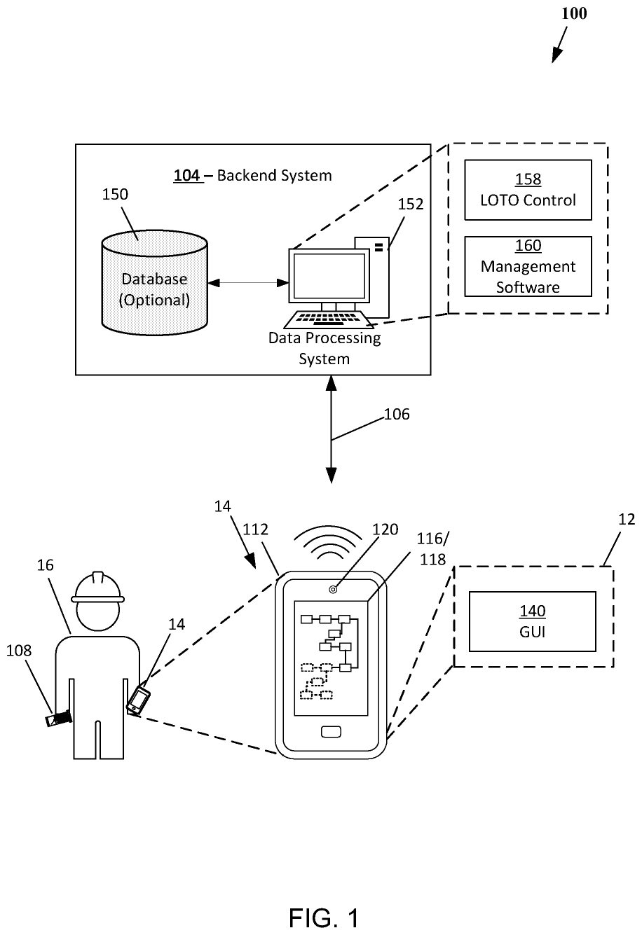

FIG. 2 shows a schematic view of a personal electronic device, in accordance with one or more arrangements.

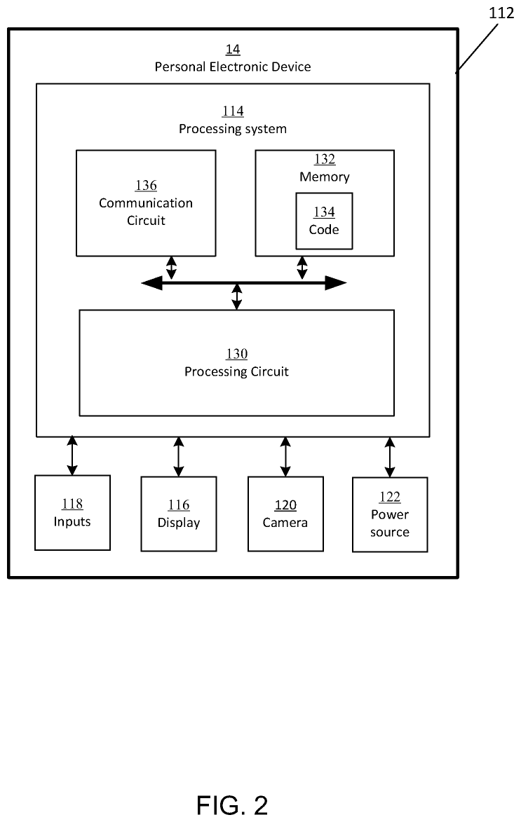

FIG. 3 is a flowchart diagram of an example process for determining sets of EIDs and EDDs for LOTO for mechanical isolation and discharge of a selected set of equipment based on an energy network data set.

FIG. 4 is a flowchart diagram of an example process for management of LOTO processes by a hazardous energy control system, in accordance with one or more arrangements; the example process configured to dynamically determine EIDs and EDDs required for LOTO for isolation of a selected set of equipment based on an energy network data set.

FIG. 5 is a flowchart diagram of an example process for management of LOTO processes by a hazardous energy control system, in accordance with one or more arrangements; the example process illustrating inter-operation and data flow between a personal electronic device and a back-end system.

FIG. 6 is a flowchart diagram of an example process performed by a back-end system in the management of LOTO processes by a hazardous energy control system, in accordance with one or more arrangements.

FIG. 7 shows an entry point of a process flow for a wizard user interface 700 of management software 160, in accordance with one or more arrangements.

FIG. 8 shows an example process to create permits for the inspection or maintenance evolution type for the process flow shown in FIG. 7, in accordance with one or more arrangements.

FIG. 9 shows an example process to create permits for the safety de-energization evolution type for the process flow shown in FIG. 7, in accordance with one or more arrangements.

FIG. 10 shows an example process to create permits for the re-energization evolution type for the process flow shown in FIG. 7, in accordance with one or more arrangements.

FIG. 11 shows an example process to create permits for the first-time energization evolution type 728 for the process flow shown in FIG. 7, in accordance with one or more arrangements.

FIG. 12 shows an example process implementing a locks-remaining subflow used by the processes shown in FIGS. 8 and 9, in accordance with one or more arrangements.

FIG. 13 shows an example process to implement a go-no-go subflow used by the processes shown in FIGS. 8, 9, 10, and 11, in accordance with one or more arrangements.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the disclosure. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the disclosure that may be described herein. The contemplated embodiments are not so limited and should not be interpreted as being restricted to embodiments which address such objects of the disclosure. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present disclosure to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of applications using lock-out-tag-out procedures for mechanically powered systems. However, the embodiments are not so limited. It is appreciated that the embodiments may be adapted for use in other applications and/or systems (e.g., electrical powered systems), which may be improved by the disclosed structures, arrangements and/or methods. The system is merely shown and described in the context of applications using lock-out-tag-out procedures for mechanically powered systems for ease of description and as one of countless examples.

### System 100

With reference to the figures, a hazardous energy control system 100 (or simply system 100) is presented. System 100 is formed of any suitable design, arrangement, and circuitry and is configured to facilitate guided LOTO and/or facilitate dynamic generation of LOTO procedures for mechanical isolation and discharge of selected equipment 44.

In one or more arrangements, the system 100 includes one or more personal electronic devices 14 and a back-end system 104 communicatively connected to the personal electronic devices 14 among other components. Personal electronic device(s) 14 and back-end system 104 are communicatively connected over one or more data networks 106.

### Personal Electronic Device 14

In one or more arrangements, system 100 includes a personal electronic device 14. Personal electronic device 14 is formed of any suitable size, shape, design, and/or technology and is configured to provide a user interface to facilitate guided LOTO by a user 16.

In the arrangement shown, as one example, personal electronic device 14 includes a housing 112, a processing system 114, a display 116, inputs 118, a camera 120, and an energy source 122, among other components. In some various arrangements, personal electronic device 14 may be a conventional cell phone, smart phone, tablet, laptop, desktop computer, or the like, however any other form of a device having a display 116 is hereby contemplated for use.

### Housing 112

In the arrangement shown, as one example, personal electronic device 14 includes a housing 112. Housing 112 is formed of any suitable size, shape, and design and is configured to provide the exterior shell of personal electronic device 14. In one arrangement shown, as one example, housing 112 is a generally elongated member that is longer than it is wide, and it is wider than it is deep and in this way housing 112 fits well within the hand of a user 16. Housing 112 houses and holds and protects the other components of personal electronic device 14.

### Processing System 114

In the arrangement shown, as one example, personal electronic device 14 includes a processing system 114. Processing system 114 is formed of any suitable size, shape, design, and/or technology and is configured to control operation of other components of personal electronic device 14 to facilitate computational operation of personal electronic device 14. In the arrangement shown, as one example, processing system 114 includes a processing circuit 130 and memory 132 having software code 134 or instructions that facilitate the display and adjustment of images on display 116, and a communication circuit 136, among other components.

Processing circuit 130 may be any computing device that receives and processes information and outputs commands according to software code 134 or instructions stored in memory 132. Memory 132 may be any form of information storage such as flash memory, ram memory, dram memory, a hard drive, or any other form of memory. Processing circuit 130 and memory 132 may be formed of a single combined unit. Alternatively, processing circuit 130 and memory 132 may be formed of separate but electrically connected components. Alternatively, processing circuit 130 and memory 132 may each be formed of multiple separate but electrically connected components.

Software code 134 or instructions are any form of information or rules that direct processing circuit 130 how to receive, interpret and respond to information to operate as described herein. Software code 134 or instructions are stored in memory 132 and accessible to processing circuit 130. As an illustrative example, in one or more arrangements, software code or instructions may configure processing circuit 130 to control camera 120, display 116 and inputs 118 to provide a graphical user interface 140 for user 16 to configure system 100 (e.g., setup account and/or user 16 preferences), select equipment 44 for isolation, and guide user 16 through a LOTO to isolate the selected equipment 44.

### Communication Circuit 136

In the arrangement shown, as one example, personal electronic device 14 includes a communication circuit 136. Communication circuit 136 is formed of any suitable size, shape, design, and/or technology and is configured to facilitate communication with back-end system 104. In one or more arrangements, as one example, communication circuit 136 includes a transceiver circuit and an antenna. A transceiver is any electronic device that facilitates two-way communication, that is, the delivery of information from personal electronic device 14 to other components of the system 100 as well as the reception of information from other components of the system 100 to personal electronic device 14. An antenna is any device that is configured to receive wireless signals from over-the-air communication and/or transmit wireless signals in over-the-air communication. In an example arrangement, a transceiver of communication circuit 136 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 136 may be configured to communicate over a wired communication channel.

### Power Source 122

In the arrangement shown, as one example, personal electronic device 14 includes a power source 122. Power source 122 is formed of any suitable size, shape, design, and/or technology and is configured to provide power to personal electronic device 14 so as to facilitate the operation of the electrical components of the personal electronic device 14. In the arrangement shown, as one example, power source 122 is formed of one or more batteries, which may or may not be rechargeable. Additionally or alternatively, in one or more arrangements, power source 122 may include a solar cell or solar panel or similar technology that may power or recharge personal electronic device 14. Additionally or alternatively, in one or more arrangements, power source 122 may be line-power that is power that is delivered from an external power source into the personal electronic device 14 through a wired connection. Any other form of a power source 122 is hereby contemplated for use.

In various arrangements, communication circuit 136 may be configured to communicate with various components of system 100 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Inputs 118

In the arrangement shown, as one example, personal electronic device 14 includes inputs 118. Inputs 118 are formed of any suitable size, shape, design, and/or technology and are configured to facilitate user 16 input of data and/or control commands. In various different arrangements, inputs 118 may include various types of controls including but not limited to, for example, buttons, switches, dials, knobs, a keyboard, a mouse, a touch pad, a touchscreen, a joystick, a roller ball, or any other form of user 16 input.

### Display 116

In the arrangement shown, as one example, personal electronic device 14 includes a display 116. Display 116 is formed of any suitable size, shape, design, and/or technology and is configured to facilitate display of information. In one or more arrangements, display 116 may include, for example, LED lights, meters, gauges, and/or a screen or monitor of a computing device, tablet, and/or smartphone. Additionally or alternatively, in one or more arrangements, the inputs 118 and/or display may be implemented on a separate device that is communicatively connected to personal electronic device 14.

### Camera 120

In the arrangement shown, as one example, personal electronic device 14 includes one or more cameras 120. Camera 120 is formed of any suitable size, shape, design, and/or technology and is configured to facilitate taking of images to facilitate account setup, scanning of QR codes or barcodes on equipment 44, and/or record keeping for LOTO procedures. In the arrangement shown, as one example, camera 120 is a built-in camera sensor forming part of personal electronic device 14. Such camera sensor may include but is not limited to, for example, a charge coupled device (CCD) sensor, a CMOS active pixel sensor, back side illuminated CMOS sensor, or any other type of camera sensor. Alternatively, camera 120 may be a separate device that is communicatively connected to personal electronic device 14.

### Graphical User Interface 140

In the arrangement shown, as one example, system 100 includes a graphical user interface 140. Graphical user interface 140 (GUI 140) is formed of any suitable size, shape, design, and/or technology and is configured to facilitate selection of devices to be isolated and guide user 16 through LOTO processes. In one or more arrangements, as one example, graphical user interface 140 may be provided by, for example, execution of a local application 12 on personal electronic device 14. Additionally or alternatively, in one or more arrangements, graphical user interface 140 may be provided by web-based application 12 executed in a web browser of the personal electronic device 14. Such web application may be, for example, a web portal hosted by a web server on back-end system 104 or by a third-party service provider.

In some various arrangements, application 12/GUI 140 provides a plurality of different interface screens for users 16 to find, view, edit, extract, or use different categories of information, features, and/or functions relating to the LOTO for mechanical isolation and discharge of selected equipment. Such information, features, and/or functions may include but are not limited to, for example: user profile information/settings, user training/certifications, equipment and components inventory tracking, equipment/component/device scan tool, lockouts, and/or verification tests, or any other useful information; features, and/or functions. U.S. Pat. No. 12,272,946 issued on Apr. 8, 2025 and titled “HAZARDOUS ENERGY CONTROL SYSTEM”, which is hereby incorporated by reference herein, describes some example user interfaces, features, and functions that may be adapted for use by Application 12/GUI 140, in accordance with one or more arrangements.

Not Limited to Any Particular System or Device

In various embodiments, personal electronic device 14 may be implemented using various different devices and/or systems to facilitate selection of equipment 44 and performance of LOTO processes by technicians. As an illustrative example, in one or more arrangements, personal electronic device 14 may be a mobile device (such as a smartphone, tablet, or laptop). However, the embodiments are not so limited. Rather it is contemplated that personal electronic device 14 may be any other form of an electronic device.

### Back-End System 104

Back-end system 104 is formed of any suitable size, shape, design and is configured to communicate with personal electronic devices 14 of users 16, perform various LOTO control processes (including dynamic generation of LOTO procedures for LOTO of equipment 44 selected by users 16), perform various management process, and/or implement various other modules, processes, or software of system 100. In the arrangement shown, as one example, back-end system 104 includes a database 150 and a data processing system 62, among other components.

### Database 150

Database 150 is formed of any suitable size, shape, design and is configured to facilitate storage and retrieval of data. In the arrangement shown, as one example, database 150 is local data storage connected to data processing system 152 (e.g., via a data bus or electronic network). However, embodiments are not so limited. Rather, it is contemplated that in one or more arrangements, database 150 may be remote storage or a cloud-based service communicatively connected to data processing system 152 via one or more external communication networks. In some various arrangements, project design files, energy matrices 42, and/or other data pertaining to system 100 may be stored in database 150.

### Data Processing System 152

Data processing system 152 is formed of any suitable size, shape, and design and is configured to facilitate receipt, storage, and/or retrieval of information in database 150, execution of LOTO control processes 158, execution of management software 160 for configuration and back-end support of system 100, and/or implementation of various other modules, processes, or software of system 100.

In one or more arrangements, for example, such a data processing system 152 includes a circuit specifically configured and arranged to carry out one or more of these or related operations/activities. For example, data processing system 152 may include discrete logic circuits or programmable logic circuits configured for implementing these operations/activities, as shown in the figures, and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

### Management Software 160 of Back-End System 104

In one or more arrangements, management software 160 is configured to provide a user interface to facilitate setup, configuration, and management of system 100. In one or more arrangements, such user interface may be accessible by a computing device provided by back-end system 104. Additionally, or alternatively, in one or more arrangements, the inputs and/or display may be implemented on a separate end user device (e.g. a personal electronic device 14) that is communicatively connected to back-end system 104. For example, in one or more arrangements, operation of back-end system 104 may be customized or controlled using a personal electronic device 14 or other computing device that is communicatively connected to the back-end system 104 (e.g., via Bluetooth, WIFI, the internet, and/or other communication network or medium).

### Generation of Energy Network Data Sets 42

In one or more arrangements, management software 160 is configured to facilitate creation of an energy network data set 42 (also referred to as energy matrix 42) for a project. An energy network data set 42 is an electronic representation of a project listing every tracked piece of equipment 44, components (e.g., energy isolating devices (EID) 46 or energy discharge devices (EDD) 48) and energy pathways therebetween, which are relevant to the safe LOTO operations in a defined scope for the project. An energy network data set 42 may be created from the project design files (e.g., electrical single line drawings, one-line drawings, electrical architectural drawings, plumbing layouts or plans, and/or other design schematics, drawings, and/or specifications).

In one or more arrangements, management software 160 provides a user interface for an approved user 16 to manually input data to define an energy network data set 42 for a project. Manual entry is conducted by a professional person that reviews and analyzes the above listed project drawings and transposes all relevant equipment 44 and EIDs into the energy network data set 42. In one or more arrangements, management software 160 provides a user interface having duplication and copy tools that enable a user to quickly enter equipment 44 and EIDs into the energy network data set 42.

Additionally or alternatively, in one or more arrangements, management software 160 is configured to automatically create an energy network data set 42 for a project from one or more project design files (e.g., electrical single line drawings, one-line drawings, electrical architectural drawings, and/or other electrical design schematics, drawings, and/or specifications).

Automatic creation of an energy network data set 42 can be done by uploading project design files to the back-end system 104 via management software 160. Management software 160 will then automatically extract information from these project design files to identify various information, which may include but is not limited to, for example, pieces of equipment and EIDs, equipment names, EID names, Isolation Point Names, number of EIDs per equipment, Number of Isolation points per equipment, and/or connections between equipment and EIDs.

Depending on the type and format of project design files provided, management software 160 may utilize various different processes and/or algorithms to extract this information. In one or more arrangements management software 160 may utilize machine learning algorithms and/or analytics to extract such information from project design files. For example, in one or more arrangements, management software 160 may utilize machine learning algorithms and/or analytics that implement character and/or object recognition to identify pieces of equipment 44 and EIDs, equipment names, EID names, Isolation Point Names, number of EIDs per equipment, Number of Isolation points per equipment, and/or connections between equipment 44 and EIDs in drawings and/or images. For instance, in one or more arrangements, management software 160 may use trained classifiers, state machines or other algorithm to provide such character and/or object recognition. In various embodiments, analysis of project design files by management software 160 may include various guided and/or unguided artificial intelligence and/or machine learning techniques including, but not limited to: neural networks, large language models (LLMs), genetic algorithms, support vector machines, k-means, kernel regression, discriminant analysis and/or various combinations thereof. In different implementations, analysis may be performed locally, remotely, or a combination thereof.

For ease of explanation, system 100 may be primarily described with reference to generation and use of a single energy network data set for a worksite. However, the arrangements are not so limited. Rather, it is contemplated that in some various arrangements, system 100 may be configured to create multiple energy network data sets for respective systems at a worksite. As one illustrative example, in one or more arrangements, management software 160 may create a first energy network data set for electrical, a second energy network data set for steam, a third energy network data set for water, and a fourth energy network data set for natural gas.

### Example Energy Network Data Set Format

Different arrangements may use various different formats and structures to define energy network data sets 42. As an illustrative example, in one or more arrangements, energy network data sets 42 are defined with a format having three primary categories: Equipment 44, EIDs 46 and EDDs 48.

### Equipment 44

In this example, each piece of equipment 44 represents a defined boundary that contains a confluence of energy pathways. In this example, all equipment 44 has at least one EID 46. In this example, there are 3 different ways to identify and categorize equipment 44 in the energy network data set: Energy sources, Passthrough, and General equipment.

Energy source—In this example, each energy network data set 42 contains at least one energy source so as to facilitate determination of LOTO isolation points by system 100 based on input energy and energy flow paths. Equipment 44 identified as energy sources create or mechanical power (e.g. pumps, motors, boilers, turbines)), store their energy (e.g., gravity feed tanks), or are identified as the source of power input (e.g., utility natural gas, oil, water, etc.). Equipment 44 identified as an energy source will not contain any Input EIDs. They can only contain Isolation Points (Ips), Output EIDs, and Bidirectional EIDs.

General Equipment—General equipment 44 is equipment 44 that is not an energy source.

Equipment Identifiers—Energy network data sets 42 may include various data fields that describe the equipment 44. In one or more arrangements, as one example, the energy network data set 42 format includes 11 data fields that may be used to identify equipment 44:
1. Equipment name.
2. Identifier—QR Code, barcode or other identifier unique to that piece of equipment 44.
3. Type—General, energy source.
4. Group—Equipment 44 can be grouped together based on identification and naming conventions to better filter and find needed equipment 44.
5. Sub-Group—Equipment 44 can be sub divided and filtered into even smaller groups based on naming conventions and identification to better filter and find needed equipment 44.
6. Location—the physical location of the piece of equipment 44 in the building and/or project.
7. # Connection Point—the number of connection points a piece of equipment 44 has available for connecting to an energy network.
8. # Connection Point Type—the type of connection point.
9. System—Indicates which system(s) a piece of equipment is included in.
10. Boundary Group—Indicates if a piece of equipment is located at a boundary of a system.
11. Component—In one or more arrangements, component tags may be used to specify information relevant to a particular component.
12. Relations Complete—In one or more arrangements, back-end system 104 is configured to automatically track status of connections to and/or from equipment 44 and determine if a piece of equipment 44 has had all mechanical connections to or from the piece of equipment 44 correctly connected. Displays either “yes” or “no.”
13. Review Status—Tells the user 16 if that piece of equipment 44 is currently in a review status and if it is, which stage of the review status it is in.

However, it should be noted that the arrangements are not limited to the identifiers and/or data structures discussed herein. Rather, it is contemplated that in some various arrangements, may utilize various additional or alternative identifiers and/or data structures.

### Energy Isolating Devices (EIDs) 46

Energy Isolating Devices (EIDs) 46 represent physical locations where energy pathways intersect. In the mechanical context, some example EIDs may include but are not limited to, for example, valves (ball valves, globe valves, butterfly valves, gate valves, check valves, and/or any other type of valve), regulators, and/or any other method or means for selectively containing mechanical energy.

In one or more arrangements, EIDs 46 are categorized into 6 types in this example energy network data sets 42 format: Input EIDs, Output EIDs, Bidirectional EIDs,, Inputs, Outputs, and Isolation Points.
1. Input EIDs—are physical points where mechanical energy enters a piece of equipment 44.
2. Output EIDs—are physical points where mechanical energy exits a piece of equipment 44.
3. Bidirectional EIDs—are physical points where mechanical energy can either ENTER or EXIT a piece of equipment 44 through a single physical point.
4. Isolation Points—are physical points that can be used to stop the transfer of mechanical energy in the system.
5. Inputs—are physical points where mechanical energy enters a piece of equipment 44 but do not contain a way to physically stop the flow of mechanical energy.
6. Outputs—are physical points where mechanical energy exits a piece of equipment 44 but do not contain a way to physically stop the flow of mechanical energy.

Ghost EIDs—In one or more arrangements, energy network data sets 42 may also specify an additional field (Ghost EIDs) that operates as a toggle that can be applied to any EID 46, and it effectively prevents that EID 46 from being identified as an isolation point. The system 100 will automatically read upstream through the ghost EID and continue upstream to another piece of equipment 44 to determine the best and safest isolation point. It is important to note that a ghost EID can still be identified as a verification test location, just not an isolation point 46 where hazardous energy can be stopped with a physical device or barrier.

### Energy Discharge Devices (EDDs) 48

Energy Discharge Devices (EDDs) 48 represent physical locations where mechanical energy can be released from a mechanical energy pathway or equipment once isolated from energy sources. In some various arrangements, EDDs 48 may include but are not limited to, for example, valves, drains, recovery tanks/bottles, tensioner mechanisms, and/or any other method or means for selectively releasing mechanical energy present. In some various arrangements, such release of mechanical energy may include but is not limited to releasing pressure, tension/force, or any other type of mechanical energy and/or draining of fluids or other materials to facilitate safe access to and/or servicing of equipment.

### Example User Interface of Management Software

In one or more arrangements, management software 160 is configured to provide a user interface to facilitate setup, configuration, and management of system 100, in accordance with one or more arrangements. In one or more arrangements for example, such a user interface may be a web-based application accessible from a web-browser of a computer communicatively connected to back-end system 104.

In some various arrangements, management software 160 provides a plurality of different interface screens for users 16 to find, view, edit, extract, or use different categories of information, features, and/or functions relating to the setup, configuration, and management of system 100. Such information, features, and/or functions may include but are not limited to, for example: equipment, EIDs, EDDs and/or other components in an energy network data set 42; users; user profile information/settings and/or user permissions/roles; lockouts; flag groups (e.g., for flagging review by group owners whenever a piece of equipment in the flag group is selected or affected by a LOTO operation); two party reviews of changes to energy network data set 42; or any other useful information; features, and/or functions. U.S. Pat. No. 12,272,946 issued on Apr. 8, 2025 and titled “HAZARDOUS ENERGY CONTROL SYSTEM”, which is hereby incorporated by reference herein, describes some example user interfaces, features, and functions that may be adapted for use by management software 160 for LOTO for mechanical isolation and discharge of selected equipment, in accordance with one or more arrangements.

### LOTO Control Processes 158 of Back-End System 104

In one or more arrangements, LOTO control processes 158 are configured to perform various processes to facilitate management of LOTO operations requested by users 16 (e.g., via personal electronic devices 14). For example, in some various arrangements, LOTO control processes 158 are configured to create LOTO procedures dynamically on-demand as LOTO operation requests are received from users 16 and manage review and approval of LOTO operations requested by users 16, among other various processes performed by back-end system 104.

### Dynamic Creation of LOTO Procedures

In one or more arrangements, LOTO control processes 158 are configured to dynamically generate a LOTO procedure from the energy network data set 42/energy matrix 42 in response to receiving a LOTO request from the personal electronic device 14 of user 16 indicating a set of equipment 44 to be isolated. As previously described herein, dynamic creation of LOTO procedures can reduce time required for LOTO in the field when multiple pieces of equipment 44 are to be isolated because the procedures can be created to avoid unnecessary placement of redundant locks 38 on EIDs 46 and/or minimize the number of locks 38 required to be placed in order to isolate a user 16 specified set of equipment 44.

In various different arrangements, LOTO control process 158 may dynamically generate LOTO procedures for selected equipment 44 using various different methods and/or processes. As a general example, in one or more arrangements, LOTO control process 158 traverses all connections in the energy network data set 42 starting from the selected equipment 44 and branching outward through all interconnected active EID connections. In one or more arrangements, the process 158 follows all connected pathways until energy sources are encountered and identified. Once the LOTO control process 158 has identified the connected energy sources, which can affect specified equipment 44, the process follows energy pathways in the energy network data set 42 backward from the identified power sources and determines the most optimal EIDs 46 for placement of locks 38 to mechanically isolate all of the specified equipment 44 from the energy sources. Once the LOTO control process 158 has identified EIDs 46 to isolate the selected equipment, the process follows energy pathways in the energy network data set 42 to identify a suitable EDD(s) 48 for discharge of mechanical energy from the selected equipment following isolation from energy sources.

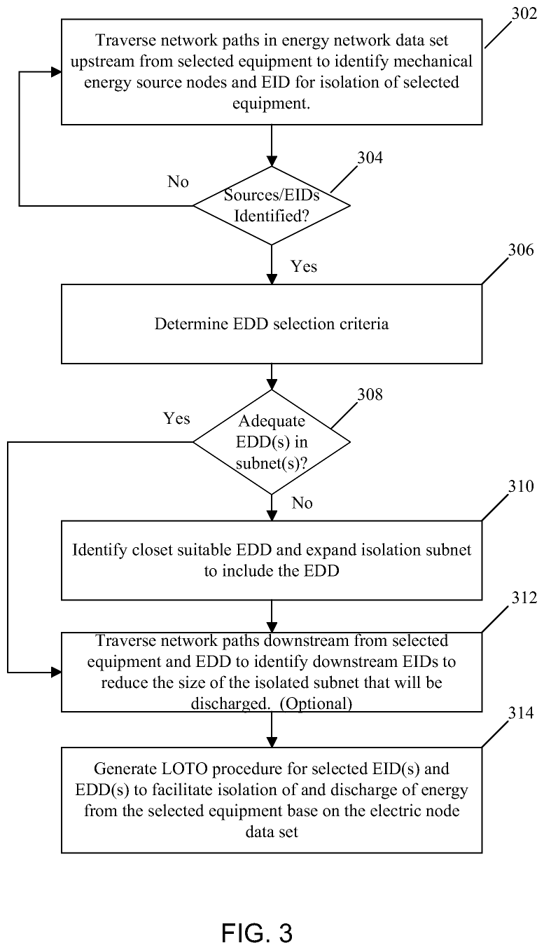

FIG. 3 shows an example high level process for selection of EIDs 46 and EDDs 48 from an energy network data set to facilitate generation of LOTO procedures, in accordance with one or more arrangements. In this example, at process block 302, network paths in the energy network data set are traversed upstream from selected equipment to identify energy sources and available EIDs. Starting at the selected equipment, the upstream branches of the isolation subnet may be iteratively expanded outward at nodes of the identified EIDs 46 until a suitable set of EIDs 46 for isolation is identified at decision block 304.

In this example, at process block 306 criteria for selection of EDDs 48 are then determined. Criteria for selection of EDDs 48 depend on the type of mechanical energy and/or material that is present in the energy network. For example, for some pressurized gas systems (e.g., natural gas or compressed air) mechanical energy can be discharged by releasing pressure either upstream or downstream of the selected equipment after isolation. Some other pressurized gas systems may need to release gas from specific locations (e.g. extraction of refrigerant from a high pressure liquid line in HVAC systems). For liquid based mechanical energy (e.g., hydraulics, water), positioning of suitable EDDs 48 upstream or downstream may depend on whether the liquid must be drained from the isolated equipment (e.g., for safety or convenient repair) or if release of pressure of the liquid is sufficient. In one or more arrangements, criteria for selection of EDDs 48 may be specified, for example, for each or each type of equipment in a database 150 of backend system 104.

If a suitable EDD is not present in the isolation subnet at decision block 308, the process proceeds to process block 310, where a suitable EDD 48 is identified and the isolation subnet is expanded (e.g., by adjusting selected EIDs 46) to include the identified EDD 48. Once a suitable EDD 48 is identified, the process proceeds from decision block 308 or process block 310 to process block 312.

In one or more arrangements, network paths may optionally be traversed downstream from the selected equipment at process block 312 to identify additional EIDs 46 that can be used to reduce the size of the isolated subnet that will be discharged using the EDDs 48. By reducing the isolated portion that will be discharged, the equipment may be discharged with the release of less material (e.g., liquid, gas, etc). In this manner, discharge and recharge times can be reduced and the amount of material that is lost or reclaimed is reduced.

In one or more arrangements, at block 314, a LOTO procedure is dynamically generated based on selected equipment to be worked on, the determined set of EIDs 46, and/or the determined EDDs 48. However, the arrangements are not limited to this example process for determining EIDs 46 and EDDs 48 for isolation and discharge of the selected equipment. Rather, it is contemplated that some various arrangements may utilize various processes with various additional or alternative steps to determine EIDs 46 and EDDs 48 for LOTO.

### Optimization of LOTO Procedures

In one or more arrangements, LOTO control processes 158 are configured are configured to optimize generated LOTO procedures to achieve various different goals, including but not limited to, for example, minimizes the number of locks 38 required to be placed, minimizes the number of EDDs 48 that are required, minimizing equipment 44 that is discharged, minimizing disrupting operation of other equipment 44, avoiding isolation of critical equipment 44, and/or any other priority or goal.

The determination and optimization of EIDs 46, EDDs 48, verification test locations, or other parameter for a LOTO procedure are performed live on demand by system 100 in response to receiving a request to isolate the specified equipment 44. In other words, there are no predetermined lock placements, discharge locations, or verification test locations. Testing of system 100 has shown that determination and optimization of EIDs 46 can be computed in approximately 1-20 seconds by back-end system 104, depending on the size of the project.

In one or more arrangements, after determining the set of EIDs 46 to be locked and verification test locations, LOTO control process 158 generates a procedure for LOTO, which is then communicated by back-end system 104 to the personal electronic device 14 of user 16. Upon receiving the LOTO procedure, the personal electronic device 14 provides a graphical user interface that guides the user 16 through the LOTO procedure.

However, the embodiments are not so limited. Rather it is contemplated that in one or more arrangements, back-end system 104 may be configured to provide steps of the determined LOTO procedure to personal electronic device 14 sequentially, for example, as personal electronic device 14 provides confirmation that the user 16 has completed previous steps. Additionally or alternatively, in one or more arrangements, back-end system 104 may be configured to communicate the determined set of EIDs 46 to be locked, EDDs 48 for discharge, and verification test locations to the personal electronic device 14, on which application 12 determines an appropriate LOTO procedure for the determined set of EIDs 46 to be locked, EDDs 48 for discharge and verification test locations.

Some various arrangements may utilize various different processes to determine procedures for LOTO for selected equipment and/or determined EIDs 46 and EDDs 48. In some arrangements, system 100 is configured to dynamically generate procedure steps to facilitate LOTO of the EIDs/EDDs and/or servicing of selected equipment.

In some arrangements, the LOTO procedure is generated by LOTO control process 158 and then communicated by back-end system 104 to the personal electronic device 14 of the user 16. In some other arrangements, selected equipment, determined EIDs 46 and EDDs 48 and/or other information may be communicated to the personal electronic device 14 of the user 16, on which one or more processes determine a procedure to be performed for LOTO and/or services of the selected equipment.

In one or more arrangements, system 100 utilizes predefined LOTO procedures for the selected equipment, with steps adjusted to facilitate LOTO using the determined EIDs 46 and EDDs 48. Additionally or alternatively, in one or more arrangements, system 100 dynamically determines procedure steps in real time. U.S. patent application Ser. No. 19,068,677, filed on Mar. 3, 2025, and titled “HAZARDOUS ENERGY CONTROL SYSTEM”, which is hereby incorporated by reference herein, describes some example systems and processes that may be utilized in system 100 to facilitate dynamic generation of LOTO procedure steps.

### In Operation

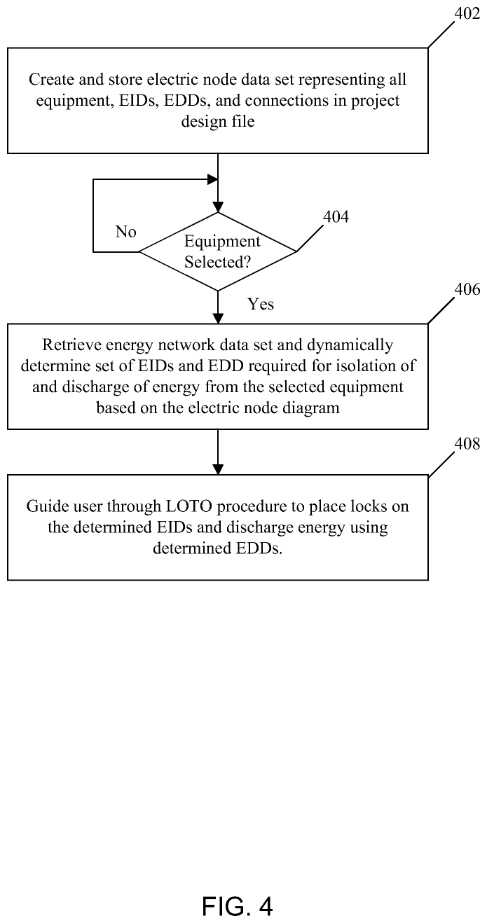

FIG. 4 shows a flow chart of an example high level process for management of LOTO processes by system 100, in accordance with one or more arrangements. At process block 402, an energy network data set 42 representing all equipment 44, EIDs 46, EDDs 48, and connections in a project design file (e.g., one-line drawing) is created and stored (e.g., in database 150 of back-end system 104). As previously discussed with reference to management software 160 of back-end system 104, system 100 may utilize various manual or automated processes to generate the energy network data set 42. In this example, the process hangs at decision block 404 until a user 16 selects (e.g., via GUI 140 on personal electronic device 14) equipment 44 to be isolated. When equipment 44 to be isolated is selected by the user, the process proceeds to process block 406, where system 100 retrieves the energy network data set 42 and dynamically determines a set of EIDs 46 required for LOTO in order to isolate the equipment 44 selected by a user 16 and a set of EDDs 48 required to discharge the equipment 44 following isolation. At process block 408, system 100 guides user 16 through a LOTO procedure to place locks 38 on the determined EIDs 46, and thereby isolate the equipment 44, and then discharge energy from the isolated equipment using the determined EDDs 48.

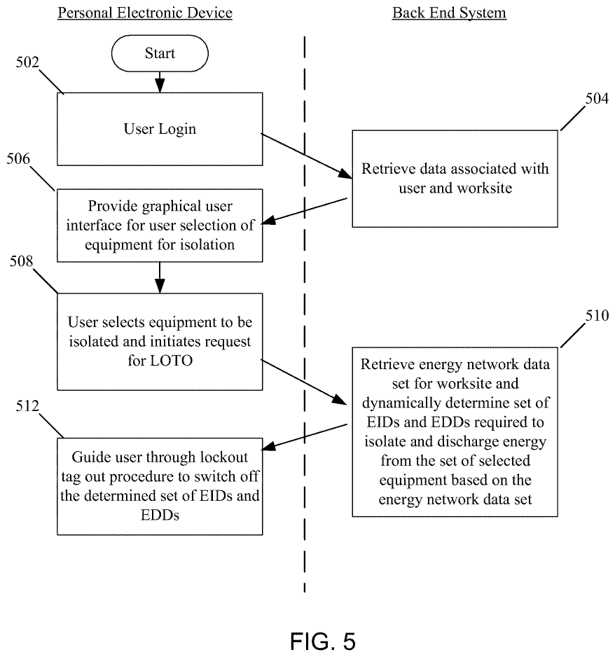

FIG. 5 shows a flow chart of an example process showing high level interaction between personal electronic device 14 and back-end system 104 in requesting and performing LOTO to isolate user-selected equipment, in accordance with one or more arrangements. In this example, the process is started at process block 502 when a user 16 logs in to application 12 on personal electronic device 14. At process block 504, the log in prompts back-end system 104 to retrieve data associated with the user 16 (e.g., from database 150). Such data may include but is not limited to, for example, personal information, a worksite associated with the user 16, one or more energy network data sets 42 for such worksite, permissible tiers 40 of the user 16, flag group memberships, locks 38 assigned to the user 16, testing devices 108 or other calibrated equipment assigned to the user 16, and/or any other information pertinent to LOTO operations of the user 16 and/or worksite.

In the arrangement shown, as one example, data is provided to personal electronic device 14 to facilitate providing of a graphical user interface (e.g., GUI 140) to the user 16 at process block 506 for the user 16 to select equipment 44 on the worksite for isolation and initiate a request for LOTO. At process block 508, using the GUI 140, the user 16 selects equipment 44 on the worksite for isolation and initiates a request for LOTO. At block 510, back-end system 104 retrieves the energy network data set 42 for the worksite containing the selected equipment 44 and dynamically determines from the energy network data set 42 a set of EIDs 46 required to be disabled in order to isolate the selected set of the equipment 44. The determined set of EIDs 46 is provided to the personal electronic device 14, where GUI 140 of application 12 guides the user 16 through procedures for LOTO of the determined set of EIDs 46 at process block 512.

### Review/Approval Processes

In one or more arrangements, LOTO control processes 158 may be configured to restrict the ability of users 16 to perform certain actions without approval (e.g., isolation of certain equipment 44, installation or modification of project equipment 44 and/or connections on site, and/or editing of energy network data set 42 for a project). The ability to restrict actions that users 16 are permitted to take may be useful, for example, to ensure that critical equipment 44 is not isolated while in use. For example, in a hospital setting, it is important to ensure that equipment 44 necessary for treatment is not isolated unless the downtime is scheduled in advance at a time the equipment 44 will not be needed.

In one or more arrangements, management software 160 is configured to provide a user interface for authorized users 16 to create and configure flag groups for pieces of equipment 44 or certain actions (e.g., to edit energy network data set 42). For example, in one or more arrangements, a flag group may be created for a piece of equipment 44 that indicates a set of reviewers to be notified when the piece of equipment 44 is selected for isolation by a user 16. In one or more arrangements, when that piece of equipment 44 is selected, LOTO control processes 158 notify all members of the flag group (e.g., by email, SMS, automated phone call, push notification, or any other form of communication). The notification lets the reviewer know that their flag group has been tripped by a LOTO action and their review and approval is required before the requested LOTO operation may proceed. Any reviewer in the flag group may approve or disapprove the flag group LOTO operation request, for example, via an interface provided by management software 160 of back-end system 104. In one or more arrangements, management software 160 permits the reviewer to be able to approve the request or disapprove the request with a comment as to why it is being disapproved. In one or more arrangements, if the request is approved, the user 16 that selected the equipment 44 in the flag group for isolation will receive a notification by the GUI 140 on their personal electronic device 14 and be allowed to move forward with their LOTO operation. In one or more arrangements, if the LOTO operation is disapproved, the user 16 will have their LOTO operation canceled. In some arrangements, the user 16 may be provided an option to modify the disapproved LOTO operation (e.g., to overcome the reason for disapproval indicated in the notification). The flag group will then log the request activity and approval/disapproval as well as the LOTO record. In one or more arrangements, management software 160 requires approval of second authorized personnel in order to create or edit a flag group. In other words, management software 160 would not permit a reviewer to approve their own request to create and/or edit a flag group.

In one or more arrangements, management software 160 and LOTO control processes 158 may additionally or alternatively utilize permissible tiers 40 to determine approvals required by flag groups and/or restrict actions of users 16 as previously described.

Permissible tiers 40 may be created by management software to permit different access to different users. For example, a tradesman would be provided lowest access such as individual lockout/tagout (LOTO) permissions only. In contrast, a foreman may be provided additional permissions for control boxes with two-party verification. Added to these permissions, a general foreman and/or general contractor supervisor would also be given control access lock permissions/energizations. These permissions might also be granted to a quality assurance/quality control team, CX-Commissioning, trade partner safety managers and/or general contractor safety managers. Lock removal permissions would be added to a tier including the overall site safety manager and/or the project administrators. In one or more arrangements, management software 160 may permit flag groups to require different approvals for different users 16 based on permissible tiers 40. Additionally or alternatively, in one or more arrangements, management software 160 and LOTO control processes 158 may designate permits that must be approved before particular LOTO procedures and/or particular actions can be performed. Such permits may designate specific individuals, groups, or permission levels required for approval of the permit. In some arrangements permits may require multiple approvals. In some arrangements, permits may require certain permission level in order for users to request approval of a permit so as to enable the user to perform a restricted procedure and/or action. Additionally or alternatively, in some arrangements, permits may specify a set of criteria that must be satisfied before a reviewer can authorize the permit. For example, in one or more arrangements, management software 160 and LOTO control processes 158 may require a user to verify that the individual specified criteria are satisfied before the ability to approve the permit is enabled. However, the arrangements are not limited to the example methods and means discussed herein for implementing approvals and/or restrictions. Rather, it is contemplated that in one or more arrangements, management software 160 and LOTO control processes 158 may additionally or alternatively utilize any other processes, techniques, and/or data metric to implement and/or trigger approvals or restrictions on users 16.

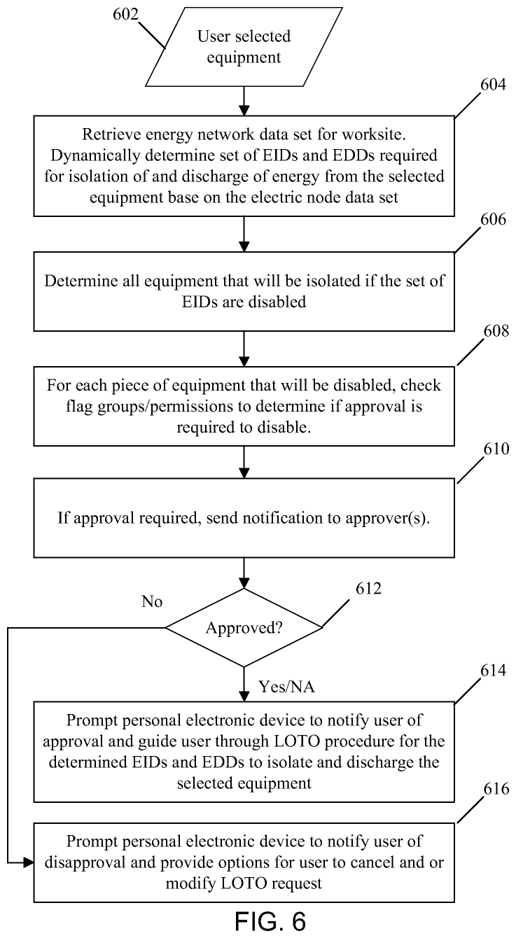

FIG. 6 shows an example high level process for management of LOTO processes by back-end system 104 that is configured to restrict the ability of users 16 to perform LOTO for certain equipment without approval. In this example, at process block 604 back-end system 104 retrieves the energy network data set 42 for the worksite containing user selected equipment 602 and dynamically determines from the energy network data set 42 a set of EIDs 46 and EDDs 48 that are required to isolate and discharge the selected set of equipment 602 as previously described.

In this example process, back-end system 104 determines if LOTO of the determined set of EIDs 46 will isolate any equipment 44 on the worksite that requires approval (e.g., as specified in a flag group). At process block 606, back-end system 104 determines all equipment 44 on the worksite that will be isolated if the determined set of EIDs 46 is engaged. At process block 608, for each piece of equipment 44 that will be isolated, back-end system 104 checks to determine if approval is required for isolation of the equipment (e.g., based on flag groups and/or user permissions tiers). For instance, in one or more arrangements, the determination if approval is required may involve checking if the piece of equipment is included in any flag groups and if so, checking to see if trigger conditions specified in the flag group to require approval are satisfied. If approval is required, back-end system 104 provides notification to one or more reviewers (e.g., listed in the flag groups) for approval for isolation of the piece of equipment. In one or more arrangements, the back-end system 104 may also provide notification to the user 16 that the requested LOTO is pending approval.

If LOTO of the affected equipment 44 is approved at decision block 612, or if no approval is required, the process proceeds to process block 614, where the personal electronic device 14 is prompted to notify the user 16 the requested isolation was approved (if previously notified that approval was pending) and personal electronic device 14 is prompted to guide the user 16 through procedures for LOTO using the determined EIDs and EDDs to isolate and discharge the user-selected equipment. If isolation of any affected equipment 44 is disapproved at decision block 612, the process proceeds from decision block 612 to process block 616, where personal electronic device 14 is prompted to notify the user 16 of the disapproval and provide options for the user 16 to either cancel the requested LOTO of modify the requested LOTO to avoid isolation of the equipment for which isolation was not approved.

In one or more arrangements, system 100 may be configured to reassess the energy network data set 42 to see if a different set of EIDs exists that can isolate the user-selected equipment 602 without isolating the disapproved equipment. For example, in some arrangements, system 100 may determine several different alternative LOTO procedures (which may require LOTO of different numbers of EIDs) for a user 16 to select as possible options to proceed. In some arrangements, system 100 may further determine if approval is needed for any of the alternative LOTO procedures and indicate to the user 16 which alternative LOTO procedures would require approval.

### Example Guide Through LOTO

In various different arrangements, system 100 may utilize various different processes to guide a user 16 through procedures for LOTO and verify that steps are properly performed. Furthermore, in various different arrangements, system 100 may utilize multiple types of LOTO operations. For example, in one or more arrangements, system 100 may be configured to facilitate four types of LOTO operations: Individual LOTO, Group LOTO, Subject Matter Expert (SME) LOTO, and Access Control LOTO.

Individual—In this example, an individual LOTO operation is designed to protect ONLY the user 16 and no one else. The system 100 will not allow any other users 16 to join this LOTO. A completed individual LOTO confers a safety and isolation status.

Group—In this example, a Group LOTO operation is designed to protect multiple users 16. This type of LOTO will be visible to any users 16 who need to work on equipment 44 covered by the group LOTO and such users 16 will be given the option by the software to join this group LOTO. A completed group LOTO confers a safety and isolation status.

Subject Matter Expert (SME)—In this example, an SME LOTO operation is designed for high risk or one-off conditions that require input of an authorized human input instead of solely software computation. SME LOTOs are for uncommon situations that may arise during operations, maintenance, testing, construction, and commissioning. It allows the most qualified individuals to establish their own isolation points and verification testing locations. In one or more arrangements, a Subject Matter Expert Lockout (SME LOTO) can only be performed by someone with SME or Admin permissions level status at the worksite. However, some arrangements may permit SME LOTO to be performed by users 16 with other permissions levels. In some arrangements, SME LOTOs can be toggled to require other user 16 participation. In some arrangements, SME LOTOs can be made “invisible” so only those that know about the SME LOTO can join it. A completed SME LOTO process does not confer a safety status as system 100 is not involved in computing and verifying isolation points.

Access Control—In this example, an access control LOTO operation is not used to safeguard life but is only used to curtail access to equipment 44. For example, while access to some equipment may not present a safety risk, it may be desirable to require certain permissions and/or approval for users 16 to access the equipment.

In one or more arrangements, a user 16 may be provided multiple options for LOTO depending on whether the determined EIDs 46 are part of an existing group LOTO. In practice, determination of EIDs 46 for a LOTO request may present three possible options for the user 16 to proceed with LOTO:
Option 1: No existing group lockout exists that meets the user's 16 specified needs. In such case, the user 16 must complete their own LOTO operation.
Option 2: A group LOTO exists that has already made your selected equipment 44 isolated. In such case, the user 16 may opt to join the selected LOTO operation and complete the required verification test (e.g., pressure check) to begin safe work (e.g., by the user completing the verification test themselves or attesting that they witness another user perform the verification test).
Option 3: Two or more active group LOTOs exist that have already made the selected equipment 44 isolated. The user 16 may opt to join the selected LOTO operations and complete the required verification tests to begin safe work.

In one or more arrangements, after determining EIDs, system 100 determines and presents available LOTO options to the user 16 so they may select how to proceed. Based on the selection by the user 16, system 100 then guides the user 16 through LOTO procedures for placement of any additional locks 38 and/or performing any required verification tests. In one or more arrangements, the process performed by the user 16 for LOTO may differ depending on which option is selected.

### Example Process for LOTO of Determined EIDs and EDDs

Step 1—System 100 prompts the user 16 to select if they are creating a new LOTO or joining an existing group LOTO (if suitable group LOTO is available). If creating a new LOTO, system 100 prompts the user 16 to select which type of LOTO operation the user 16 would like to start. To create a new individual LOTO the process proceeds as follows.
Step 2—System 100 prompts the user 16 to scan or otherwise identify a lock box (e.g., by scanning a QR code or barcode on the lock box using camera 120 on personal electronic device 14) to assign the lock box to the LOTO operation and enter its storage location.
Step 3—System 100 prompts the user 16 to acknowledge the safety/training notice(s).
Step 4—System 100 prompts the user 16 to review the entire list of EID isolation points that have been selected by system 100 and for placement of locks 38 and select one of the unlocked EIDs as the next location for the LOTO operation.
Step 5—System 100 prompts the user 16 to select the type of lock 38 user 16 will be using during this LOTO operation.
Step 6—System 100 prompts the user 16 to scan or otherwise identify the EID identified as a required isolation point (e.g., by scanning a QR code or barcode on the EID using camera 120 on personal electronic device 14). Should the user 16 scan or otherwise identify the wrong EID, System 100 provides the user 16 with a warning (e.g., a POP UP) telling them that the EID they have scanned/identified is not compatible with their LOTO procedure and will not protect them from hazardous electrical energy. System 100 then prompts the user 16 to re-scan/identify the correct EID and provides the user 16 the location of the EID, its name, the name of the equipment 44, and the barcode identifier of the correct EID again. System 100 will not allow the user 16 to continue this LOTO operation until the user 16 has scanned/identified the correct EID. This ensures compliance and reduces human error in this process.
Step 7—System 100 prompts the user 16 to scan or otherwise identify the lock 38 that the user 16 will place on the EID to physically stop the flow of hazardous electrical energy (e.g., by scanning a QR code or barcode on the lock 38 using camera 120 on personal electronic device 14). In this example, upon scanning/identifying the lock 38, the system electronically couples the lock 38 to this EID and records this lock placement for this LOTO on the equipment's 46 activity log, on the EID's activity log, and on the lock's 38 activity log. If the user 16 has grabbed a lock 38 that is not checked out directly to the user 16, system 100 indicates to user 16 that they cannot use this lock 38 because it is either owned by someone else or it has not been checked out for use by the user 16.
Step 8—Once the lock 38 is scanned/identified, system 100 prompts the user 16 to place the lock 38 on the EID, per procedure, and then take a picture of the hanging lock 38 using camera 120 on personal electronic device 14. System 100 stores this picture as part of the LOTO record.
Step 9—Following the picture, system 100 prompts the user 16 to take the key from the lock 38 and place it into the lockbox.
Steps 4-9 are repeated until all locks 38 have been placed and recorded on all required EIDs 46. In one or more arrangements, after all required locks 38 are placed, system 100 may require the user 16 to perform a key confirmation starting at step 10.
Step 10—System 100 prompts the user 16 to take pictures as one group or smaller groups of the keys from the locks 38 placed on EIDs on the project, with their serial numbers visible in the picture. The pictures and keys are taken inside the lock box. Once all keys have a picture associated with them, the process may proceed with the next step.
Step 11—System 100 prompts the user 16 to scan or otherwise identify a lock 38 to be placed on the lock box to secure it shut. This lock 38 is referred to as the master lock. If the lock 38 scanned/identified is not checked out by the user 16 or is owned by another user 16, system 100 will inform the user 16 and instruct him to check out the lock 38 or retrieve another lock 38.
Step 12—Once the master lock is scanned/identified, system 100 prompts the user 16 to lock the lock box and take a picture of the locked lock box. This picture is then associated with the LOTO record.
Step 13—In this example arrangement, after all required locks 38 are placed, system 100 requires the user 16 to discharge the selected equipment using the determined set of EDDs as described in Steps 14-17.
Step 14—System 100 prompts the user 16 to review the entire list of the determined EDDs 48 and select one for discharge.
Step 15—System 100 directs the user to the selected EDD 48 and prompts the user 16 to scan or otherwise identify the EDD 48 (e.g., by scanning a QR code or barcode on the EDD 48 using camera 120 on personal electronic device 14). Should the user 16 scan or otherwise identify the wrong EDD 48, System 100 provides the user 16 with a warning (e.g., a POP UP) telling them that the EDD 48 they have scanned/identified is not compatible with their LOTO procedure and should not be used for discharge of mechanical energy. System 100 then prompts the user 16 to re-scan/identify the correct EDD 48 and provides the user 16 the location of the EDD 48, its name, the name of the equipment 44, and the barcode identifier of the correct EDD 48 again. System 100 will not allow the user 16 to continue this LOTO operation until the user 16 has scanned/identified the correct EDD 48. This ensures compliance and reduces human error in this process.
Step 16—System 100 prompts the user 16 to acknowledge the safety/training notice(s) corresponding to the identified EDD 48.
Step 17—System 100—then guides the user through a discharge process using the EDD 48.
Steps 14-17 are repeated for all of the EDDs 48 determined for the LOTO procedure.

In this example arrangement, after discharge has been performed for all determined EDDs 48, system 100 prompts user to perform any required verifications tests at computed test locations to ensure selected equipment is properly isolated and energy is discharged. Depending on the type of mechanical energy and/or equipment, such testing may include taking pressure measurements, temperature measurements, fluid level measurements, PH measurements or other chemical testing, tension force measurements, or any other measurement or test relating to mechanical energy systems. In some various arrangements, verification tests may utilize sensors, gauges, or other testing components preinstalled in the equipment or various locations in a mechanical energy network. Additionally or alternatively, in some arrangements, verification tests may utilize portable sensors, gauges, or other testing components, configured to a mechanical energy network at verification test locations.
Step 18—System 100 prompts the user 16 to review a listing of all the live computed verification test locations, and to select one of the untested locations for verification testing. In this example, all equipment names, locations, names, and the barcode for the specific testing components or testing location are listed.
Step 19—System 100 prompts the user 16 to scan or otherwise identify the EID 48, EDD 48, or other component that the user 16 intends to test (e.g., by scanning a QR code or barcode on the EID 46 using camera 120 on personal electronic device 14). If the user 16 does not scan/identify the correct verification test location, system 100 provides a warning (e.g., a POP UP) telling them that the verification test location they have scanned/identified is not compatible with their LOTO procedure and will not protect them from hazardous electrical energy. The user 16 will not be able to move forward with this verification test until the correct verification test location is scanned/identified.
Step 20—Once the correct verification test location is scanned/identified, if a verification test is to be performed with an external testing device, system 100 prompts the user 16 to scan or otherwise identify the testing device 108 (e.g., sensor or gauge) that the user 16 will use for safety verification testing (e.g., by scanning a QR code or barcode on the testing device 108 using camera 120 on personal electronic device 14). In one or more arrangements, system 100 is configured to assess the scanned/identified testing device 108 to verify that the testing device 108 is an appropriate type and/or that calibration of the testing device 108 has not expired. An example process for assessment of the testing device 108.

In one or more arrangements, verification tests require measurement/testing to be performed at a mechanically energized location in addition to the mechanically discharged verification test location, so as to ensure the measuring device is working properly. For verification/tests performed with preinstalled sensors, gauges, or other testing components, in some arrangements, verification testing may require taking a measurement in a mechanically charged state (prior to discharged at step 13) followed by testing in the presumably discharged state at step 20.

Once all tests have been completed, the LOTO will be complete and their unique LOTO operations identifier will show up on the screen and let the user 16 know this LOTO is now complete and active.

Although some example LOTO processes may be described with reference to scanning of locks 38, lock boxes, equipment 44, EIDs 46, EDDs 48, testing components, and/or other components, the embodiments are not so limited. Rather, it is contemplated that various arrangements may be adapted to utilize any means or method for a user to identify locks 38, lock boxes, equipment 44, EIDs 46, EDDs 48, testing components, and/or other components. For example, in one or more arrangements, graphical user interface 140 of system 100 may be configured to permit the user 16 to manually enter an identifier (e.g., an equipment name or serial number on a tag of the locks 38, lock boxes, equipment 44, EIDs 46, EDDs 48, testing components, and/or other components) to confirm the user 16 is at, testing, or using the correct device and/or location. As another example, in one or more arrangements, a user may utilize a search interface to locate and identify a particular to confirm the user 16 is at, testing, or using the correct device and/or location. As another example, in one or more arrangements, a user may browse through an index, or hierarchical listing, or other arrangement to locate and identify a particular to confirm the user 16 is at, testing, or using the correct device and/or location.

### Example Group LOTO Process

In one or more arrangements, the process for Group LOTO is similar to the above process for individual LOTO with the following revisions:
Modified step 1—If a user 16 selects pieces of equipment 44 that are on the isolated or protected list of an active group LOTO, the user 16 will be given a separate review page notifying them that an active group LOTO already exists and prompting them to join the existing active group LOTO. This page lets the user 16 virtually review the active group LOTO and provides the following information: the unique LOTO identifier, the name of the LOTO creator/Owner, the time stamps associated with this LOTO, all locks 38 placed for this LOTO, including their pictures, locations and time stamps, all verification test information for this LOTO, and a list of all active users 16 that are currently locked out on this group LOTO already.
Modified steps 2-12.—If the user elected to join the group LOTO, in lieu of steps 2-12 the user 16 is prompted to scan or otherwise identify the lock box associated with the correct active group LOTO at step 2. Should they scan/identify the wrong lock box, system 100 notifies the user 16 (e.g., via a pop up) to tell the user 16 they scanned/identified the incorrect lock box and give them the lockbox number they are looking for. The software will not allow them to continue until they have selected the correct lock box. Once the correct lock box has been identified, the user 16 will be asked to scan or otherwise identify their lock 38 that they will place on the lock box. If the user 16 owns this lock 38 and it is correctly checked out to them, they will successfully scan/identify and lock the lock 38 on the lock box. User 16 is then prompted to take a picture of their lock 38 on the lock box.
Modified steps 13-20—Following modified steps 2-12, in this example verification test sequence, the user 16 is presented with two options for discharge and/or verification testing: 1) they can perform discharge and/or verification tests as indicated in steps 13-20 or 2) they may perform “witnessed” discharge and verification testing in lieu of steps 13-20. If witnessed discharge and verification is selected, system 100 requires user 16 to acknowledge that they witnessed an individual perform discharge and verification testing on the equipment. For example, in one or more arrangements, the user 16 is provided a list of the individuals that have recorded actual discharge and verification data for this active live group LOTO. The user 16 will select the individual from this list and acknowledge a prompt that says they did actually witness this test in person. Once selected, their LOTO operation will be completed, and a green screen will tell them a unique LOTO identifier has been created and their equipment 44 specified for the LOTO is safe to begin work.

### Example Access Control Lockout

In one or more arrangements, access control lockouts may be created by anyone with supervisor permissions level status or higher at the worksite and are used to control access to a specific piece of equipment 44 for non-maintenance related reasons. However, some arrangements may permit placement of access control locks with other permissions levels. These access control locks will not be placed on electrical components themselves but rather on the closest physical access point. In this example, an access control lockout may be created in the same manner as a group lockout.

### Example SME LOTO Process

SME LOTO follows a very similar process in steps 1-20 but EIDs are specified by the user 16 instead of being dynamically computed by system 100. That is instead of selecting which pieces of equipment 44 the user 16 wants to completely isolate, the user 16 selects the pieces of equipment 44 that they are going to dictate to system 100 where they will be placing locks. For instance, rather than the user 16 selecting the EID for placement of a lock at step 5 from the computed list presented at step 4, the user 16 may scan/identify an EID of their choosing at step 6. In this example, system 100 then checks this equipment list against each EID scanned/identified by the user 16 to ensure that the EID is associated with a piece of equipment 44 in this list. In this way it ensures that the user 16 is still placing their locks in the correct positions on the correct pieces of equipment 44. The LOTO process then proceeds in the same manner as indicated in steps 7-18.

In one or more arrangements, once an SME LOTO is completed, the user 16 has the ability to be toggled from visible to invisible. An invisible SME LOTO will not notify other users 16 of its active status in system 100 and will not show up as an option to join this LOTO. A visible SME LOTO will require users 16 to join the LOTO if they select a piece of equipment 44 that triggers the protection logic of system 100 based on the SME LOTOs purpose and protection requirements. These protection requirements for joining are based on, for example, an equipment list specified by the LOTO creator.

It should be understood that the embodiments are not limited to the example LOTO processes provided herein. Rather, it is contemplated that in one or more arrangements system 100 may utilize various alternative LOTO processes with various steps added, modified, and/or omitted.

### Combined Mechanical and Electrical Energy LOTO

In one or more arrangements, hazardous energy control system 100 is configured to facilitate guided LOTO and/or facilitate dynamic generation of LOTO procedures for both electrical and mechanical energy systems. Such capability is thought to be particularly useful for sites having systems with mechanical energy hazards as well as electrical energy hazards. As some non-limiting examples, such systems may include but are not limited to, for example, steam generators, chillers, HVAC systems, water pumps, air operated flow valves, hydraulic systems, etc. In one or more arrangements, system 100 is configured to require that such a system be isolated from all mechanical and electrical energy sources prior to servicing. In one or more arrangements, after equipment is selected by a user, system 100 automatically determines what electrical and/or mechanical energy systems are included and evaluates the networks of the determined energy systems to determine respective LOTO subprocesses. In one or more arrangements, LOTO subprocesses for mechanical energy systems may be determined as described herein. LOTO subprocesses for electrical energy systems may be determined as described in U.S. Pub. No. 2025/0202277 titled “HAZARDOUS ENERGY CONTROL SYSTEM” and published Jun. 19, 2025, which is hereby incorporated by reference herein. In one or more arrangements, the LOTO subprocesses may then be combined to form a LOTO process for the selected equipment.

### Wizard User Interface 700

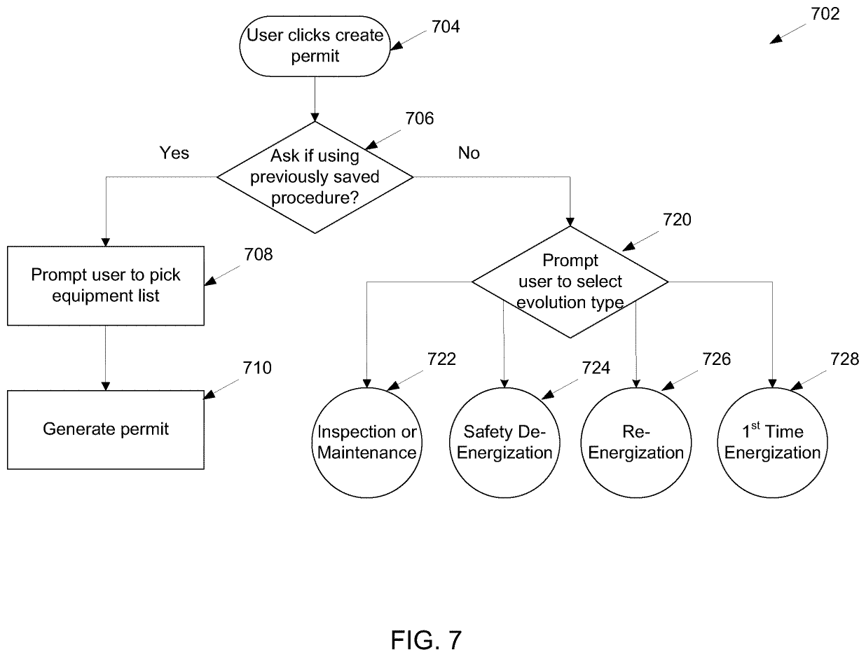

In one or more arrangement, management software 160 includes a wizard user interface 700 (not shown) configured to facilitate easy scheduling of tasks/maintenance, creation of LOTO processes, and issuing of permits. FIGS. 7-13 show an example process 702 performed by the wizard user interface 700 in accordance with one or more arrangements. In this example, the process guides a user through a process of selecting and/or generating a LOTO plan for work to be performed and generating of a permit for the user to perform the LOTO.

FIG. 7 shows the entry point of the wizard user interface 700 process flow for creation of permits for LOTO, in accordance with one or more arrangements, in accordance with one or more arrangements. The user initiates the process by clicking a “create permit” button of wizard user interface 700 at process block 704. The system then asks whether the user is using a previously saved procedure at decision block 706. If yes, the system prompts the user to pick an equipment list at process block 708 and then generates the permit at process block 710. If no, the system prompts the user to select an evolution type of the contemplated work/task at decision block 720. In this example, available evolution types include inspection or maintenance 722, safety de-energization 724, re-energization 726, and first-time energization 728.

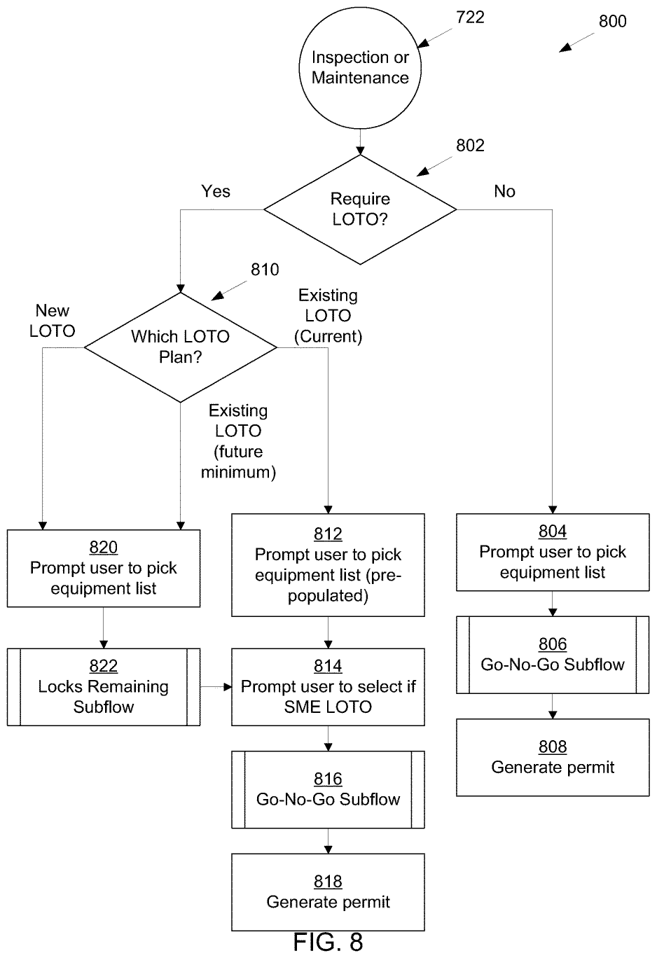

FIG. 8 shows an example process 800 to create permits for the inspection or maintenance evolution type 722, in accordance with one or more arrangements. The system first determines whether LOTO is required at decision block 802. If LOTO is not required, the system prompts the user to pick an equipment list at process block 804, proceeds through the go-no-go subflow at process block 806, and generates the permit at process block 808. If LOTO is required, the system asks which LOTO plan applies at decision block 810. For a new LOTO, the user is prompted to pick an equipment list at process block 820, and the locks-remaining subflow is performed at process block 822. For an existing current LOTO or an existing future-minimum LOTO, the system prompts the user to pick a pre-populated equipment list at process block 812, prompts the user to select whether the LOTO is SME LOTO at process block 814, performs the go-no-go subflow at process block 816, and generates the permit at process block 818.

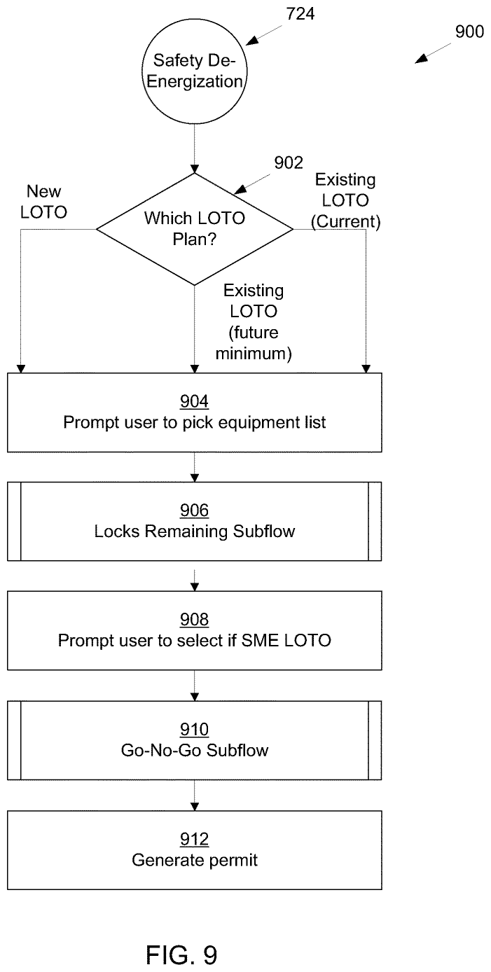

FIG. 9 shows an example process 900 to create permits for the safety de-energization evolution type 724, in accordance with one or more arrangements. The system asks which LOTO plan applies at decision block 902, with paths for a new LOTO, an existing current LOTO, or an existing future-minimum LOTO. The system then prompts the user to pick an equipment list at process block 904, performs the locks-remaining subflow at process block 906, prompts the user to select whether the LOTO is SME LOTO at process block 908, performs the go-no-go subflow at process block 910, and generates the permit at process block 912.

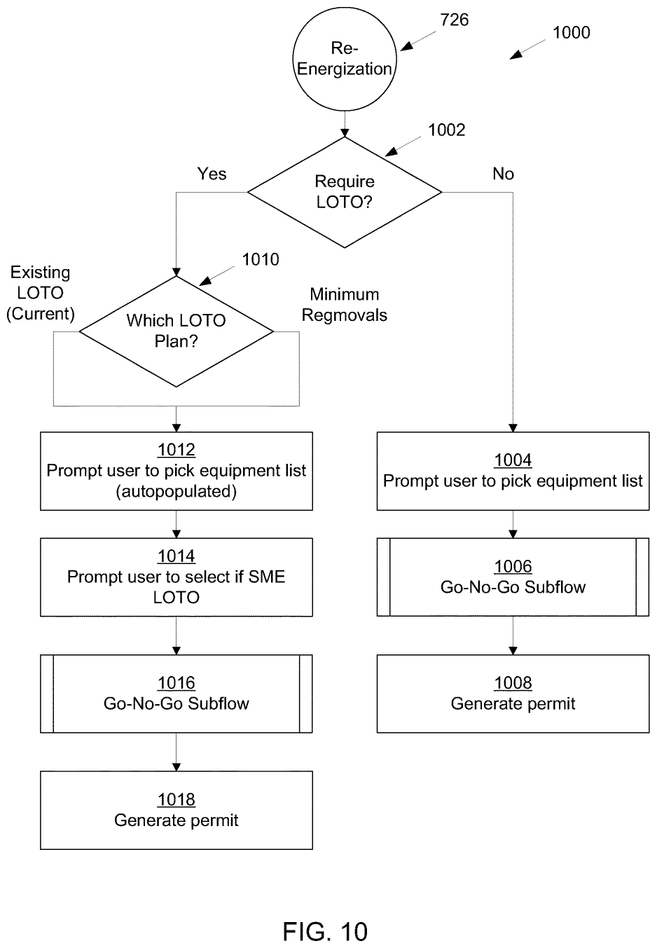

FIG. 10 shows an example process 1000 to create permits for the re-energization evolution type 726, in accordance with one or more arrangements. The system first determines whether LOTO is required at decision block 1002. If LOTO is not required, the system prompts the user to pick an equipment list at process block 1004, performs the go-no-go subflow at process block 1006, and generates the permit at process block 1008. If LOTO is required, the system asks which LOTO plan applies at decision block 1010. In this example, the LOTO plan options include using an existing LOTO (current) or a LOTO with minimum removals. For each option, the system then prompts the user to pick an auto-populated equipment list at process block 1012, prompts the user to select whether the LOTO is SME LOTO at process block 1014, performs the go-no-go subflow at process block 1016, and generates the permit at process block 1018.

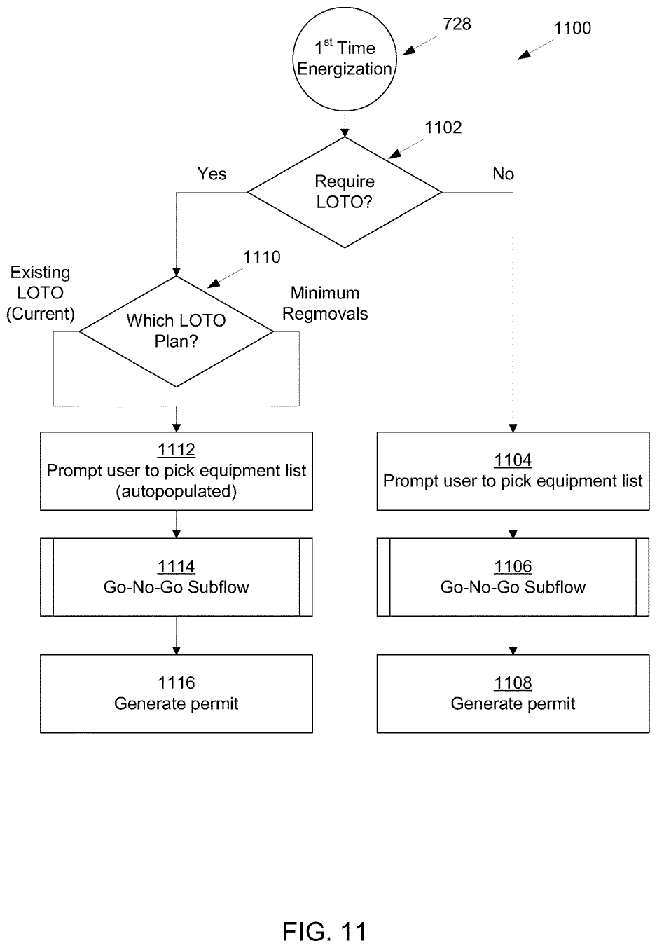

FIG. 11 shows an example process 1100 to create permits for the first-time energization evolution type 728, in accordance with one or more arrangements. The system determines whether LOTO is required at decision block 1102. If LOTO is not required, the system prompts the user to pick an equipment list at process block 1104, performs the go-no-go subflow at process block 1106, and generates the permit at process block 1108. If LOTO is required, the system asks which LOTO plan applies at decision block 1110, including an existing current LOTO path and a minimum removals path. The system prompts the user to pick an auto-populated equipment list at process block 1112, performs the go-no-go subflow at process block 1114, and generates the permit at process block 1116.

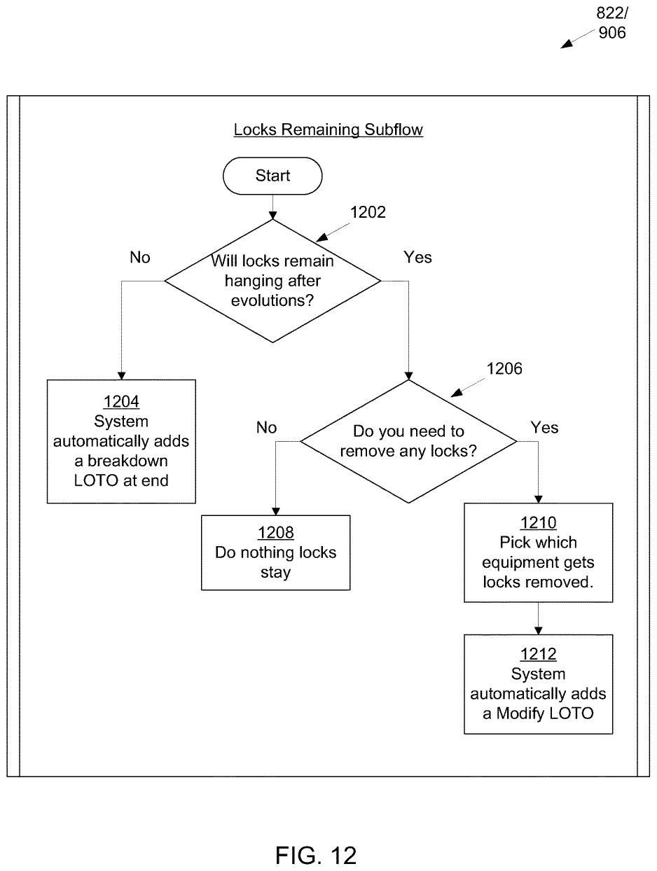

FIG. 12 shows an example process implementing the locks-remaining subflow (e.g., 822 and/or 906), in accordance with one or more arrangements. The subflow begins by determining whether locks will remain hanging after the evolution at decision block 1202. If no locks will remain, the system automatically adds a breakdown LOTO at the end at process block 1204. If locks will remain, the system asks whether any locks need to be removed at decision block 1206. If no locks need to be removed, no further action is taken and the locks stay at process block 1208. If locks do need to be removed, the user selects which equipment will have locks removed at process block 1210, and the system automatically adds a modify LOTO at process block 1212.

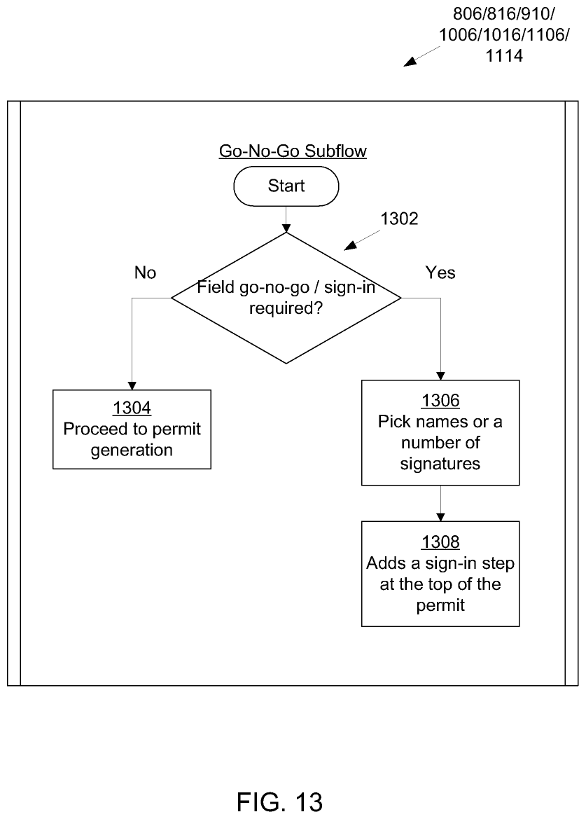

FIG. 13 shows an example process to implement the go-no-go subflow (e.g., 806, 816, 910, 1006, 1016, 1106, and/or 1114), in accordance with one or more arrangements. The subflow begins by determining whether a field go-no-go or sign-in is required at decision block 1302. If not required, the process proceeds to permit generation at process block 1304. If required, the user selects names or a number of signatures at process block 1306, and the system adds a sign-in step at the top of the permit at process block 1308.

From the above discussion and accompanying figures and claims it will be appreciated that the disclosed systems offer many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

1. A hazardous energy control system, comprising:
a back-end system;
the back-end system having a memory;
wherein the back-end system is configured to store in the memory data indicating a set of equipment at a worksite;
a personal electronic device communicatively connected to the back-end system;
wherein the personal electronic device is configured to provide a user interface for a user to select a first subset of equipment, from a set of equipment at the worksite, for mechanical energy isolation from hazardous energy sources via lockout/tagout (LOTO);
wherein in response to receiving a request for LOTO of the first subset of equipment, the back-end system is configured to determine a LOTO procedure for mechanical energy isolation and discharge of the first subset of equipment.

2. The system of claim 1, wherein the determined LOTO procedure includes:
isolating the first subset of equipment from the hazardous energy sources using a set of energy isolation devices (EIDs) at the worksite; and
discharging mechanical energy from the first subset of equipment using a set of energy discharge devices (EDDs) at the worksite.

3. The system of claim 1, wherein the determining of the LOTO procedure includes:
determining a set of one or more energy isolation devices (EIDs) at the worksite required for isolation of the first subset of equipment;
determining a set of one or more energy discharge devices (EDDs) at the worksite required for discharge of mechanical energy from the first subset of equipment following isolation.

4. The system of claim 1, wherein the determining of the LOTO procedure includes:
determining a set of one or more energy isolation devices (EIDs) at the worksite required for isolation of the first subset of equipment;
determining a set of one or more energy discharge devices (EDDs) at the worksite required for discharge of mechanical energy from the first subset of equipment following isolation; and
wherein the determined LOTO procedure includes:
isolating the first subset of equipment from the hazardous energy sources using the set of EIDs; and
discharging mechanical energy from the first subset of equipment using the set of EDDs.

5. The system of claim 1, wherein the determined LOTO procedure includes:
isolating the first subset of equipment from the hazardous energy sources using a set of EIDs at the worksite; and
discharging mechanical energy from the first subset of equipment using a set of EDDs at the worksite;
wherein the back-end system is configured to optimize the LOTO procedure to minimize the number of the set of equipment that is isolated and discharged of mechanical energy.

6. The system of claim 1, wherein the determined LOTO procedure specifies one or more reviewers authorized to give approval before the LOTO procedure can be performed.

7. The system of claim 1, wherein the determined LOTO procedure specifies one or more reviewers authorized to give approval before the LOTO procedure can be performed; wherein the back-end system is further configured to communicate the LOTO procedure to the personal electronic device in response to at least one of the one or more reviewers approving isolation of the second subset of equipment.

8. The system of claim 1, wherein the back-end system is further configured to cause the personal electronic device to guide the user through LOTO of the set of equipment using the determined LOTO procedure.

9. The system of claim 1, wherein the user interface provided by the personal electronic device is a web-based application hosted by the back-end system.

10. The system of claim 1, wherein the user interface provided by the personal electronic device is a local application downloaded from the back-end system.

11. The system of claim 1, wherein the back-end system is further configured to cause the personal electronic device to guide the user through LOTO of the set of equipment using the determined LOTO procedure;
wherein in guiding the user through LOTO of the set of equipment, the personal electronic device requires the user to perform a verification test to verify the first subset of equipment is discharged of mechanical energy.

12. The system of claim 1, wherein the back-end system is configured to optimize the LOTO procedure to minimize a number of locks that will need to be placed on an energy isolation device at the worksite.

13. The system of claim 1, wherein the back-end system is configured to optimize the LOTO procedure to minimize the isolation of pieces of equipment that are not included in the first subset of equipment.

14. The system of claim 1, wherein the back-end system is configured to optimize the LOTO procedure to avoid isolation of the pieces of the set of equipment that are identified as critical equipment in the memory of the back-end system.

15. A hazardous energy control system, comprising:
a back-end system;
the back-end system having a memory;
wherein the back-end system is configured to store in the memory data indicating a set of equipment at a worksite;
a personal electronic device communicatively connected to the back-end system;
wherein the personal electronic device is configured to provide a user interface for a user to select a first subset of equipment, from a set of equipment at the worksite, for mechanical energy isolation from hazardous energy sources via lockout/tagout (LOTO);
wherein in response to receiving a request for LOTO of the first subset of equipment, the back-end system is configured to determine a LOTO procedure for mechanical energy isolation and discharge of the first subset of equipment;
wherein the determined LOTO procedure includes:
isolating the first subset of equipment from the hazardous energy sources using a set of energy isolation devices (EIDs) at the worksite; and
discharging mechanical energy from the first subset of equipment using a set of energy discharge devices (EDDs) at the worksite.

16. The system of claim 15, wherein the determining of the LOTO procedure includes:
determining a set of one or more EIDs at the worksite required for isolation of the first subset of equipment;
determining a set of one or more energy discharge devices (EDDs) at the worksite required for discharge of mechanical energy from the first subset of equipment following isolation.

17. The system of claim 15, wherein the back-end system is configured to optimize the LOTO procedure to minimize the number of the set of equipment that is isolated and discharged of mechanical energy.

18. The system of claim 15, wherein the determined LOTO procedure specifies one or more reviewers authorized to give approval before the LOTO procedure can be performed.

19. The system of claim 15, wherein the determined LOTO procedure specifies one or more reviewers authorized to give approval before the LOTO procedure can be performed; wherein the back-end system is further configured to communicate the LOTO procedure to the personal electronic device in response to at least one of the one or more reviewers approving isolation of the second subset of equipment.

20. The system of claim 15, wherein the back-end system is further configured to cause the personal electronic device to guide the user through LOTO of the set of equipment using the determined LOTO procedure.

21. The system of claim 15, wherein the user interface provided by the personal electronic device is a web-based application hosted by the back-end system.

22. The system of claim 15, wherein the user interface provided by the personal electronic device is a local application downloaded from the back-end system.

23. The system of claim 15, wherein the back-end system is further configured to cause the personal electronic device to guide the user through LOTO of the set of equipment using the determined LOTO procedure;
wherein in guiding the user through LOTO of the set of equipment, the personal electronic device requires the user to perform a verification test to verify the first subset of equipment is discharged of mechanical energy.

24. The system of claim 15, wherein the back-end system is configured to optimize the LOTO procedure to minimize a number of locks that will need to be placed on an energy isolation device at the worksite.

25. The system of claim 15, wherein the back-end system is configured to optimize the LOTO procedure to minimize the isolation of pieces of equipment that are not included in the first subset of equipment.

26. The system of claim 15, wherein the back-end system is configured to optimize the LOTO procedure to avoid isolation of the pieces of the set of equipment that are identified as critical equipment in the memory of the back-end system.

27. A hazardous energy control system, comprising:
a back-end system;
the back-end system having a memory;
wherein the back-end system is configured to store in the memory data indicating a set of equipment at a worksite;
a personal electronic device communicatively connected to the back-end system;
wherein the personal electronic device is configured to provide a user interface for a user to select a first subset of equipment, from a set of equipment at the worksite, for isolation from hazardous energy sources via lockout/tagout (LOTO);
wherein in response to receiving a request for LOTO of the first subset of equipment, the back-end system is configured to determine a LOTO procedure for isolation and discharge of the first subset of equipment.

28. The system of claim 27, wherein the hazardous energy sources include one or more mechanical energy sources.

29. The system of claim 27, wherein the hazardous energy sources include one or more electrical energy sources.

30. The system of claim 27, wherein the hazardous energy sources include one or more mechanical electrical energy sources and one or more electrical energy sources.

31. The system of claim 27, wherein the user interface is configured to provide a wizard type dialog for creation of a permit for the LOTO of the first subset of equipment.
